(19) United States
(12) Patent Application Publication
(10) Pub. No.: US 2009/0140844 A1
(43) Pub. Date: Jun. 4, 2009

(54) Method and Apparatus for Timer Event Management

(75) Inventor: Diganta Roychowdhury, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 11/949,228

(22) Filed: Dec. 3, 2007

(51) Int. Cl. G08B 1/00

(52) U.S. Cl. 340/309.16

(57) ABSTRACT

A method comprising receiving a timer event request and generating a timer event based at least in part on at least one criterion other than a discrete timer event associated with the timer event request.

### TECHNICAL FIELD

The present application relates generally to operating system timer management.

### BACKGROUND

The modern era of electronic devices has seen a dramatic increase in the number of battery powered devices. These devices are experiencing an unprecedented growth in consumer demand. As they become more prevalent, consumer expectations relating to the longevity of device operation for a single battery charge has also been increasing. In parallel to the increasing importance of battery powered devices, there is an increasing demand for more efficient usage of conventional power, such as electricity provided by a utility company. Therefore, the importance of power efficiency is not isolated to battery powered devices, but has grown to encompass all electronic and electrical devices.

Sleep capabilities in devices using microprocessors have provided a powerful mechanism to reduce power consumption of such devices by slowing or ceasing certain operations until normal operation is desired. This sleep capability has allowed devices to save power by limiting the power consumed by the microprocessor system, at least in part, to that power which is used during the actual performance of required operations.

### SUMMARY

In accordance with an embodiment of the present invention, a method, comprising receiving a timer event request and generating a timer event based at least in part on at least one criterion other than a discrete timer event associated with said timer event request.

In accordance with another embodiment of the present invention, A computer program product comprising at least one computer-readable storage medium having computer-readable program code portions stored therein, the computer-readable program code portions comprising a first executable portion for receiving a timer event request and a second executable portion for generating a timer event based at least in part on at least one criterion other than a discrete timer event associated with said timer event request.

In accordance with another embodiment of the present invention, an apparatus, comprising a processing element configured to receive a timer event request and generate a timer event based at least in part on at least one criterion other than a discrete timer event associated with said timer event request.

In accordance with another embodiment of the present invention, a method comprising, sending a timer event request and sending at least one criterion to provide at least partial basis for generation of a timer event associated with said timer event request other than a discrete timer event.

In accordance with another embodiment of the present invention, a computer program product comprising at least one computer-readable storage medium having computer-readable program code portions stored therein, the computer-readable program code portions comprising a first executable portion for sending a timer event request and a second executable portion for sending at least one criterion to provide at least partial basis for generation of a timer event other than a discrete timer event associated with said timer event request.

In accordance with another embodiment of the present invention, an apparatus, comprising a processing element configured to send a timer event request and send at least one criterion to provide at least partial basis for generation of a timer event associated with said timer event request other than a discrete timer event.

### BRIEF DESCRIPTION OF THE DRAWINGS

For a more complete understanding of embodiments of the present invention, the objects and advantages thereof, reference is now made to the following descriptions taken in connection with the accompanying drawings in which:

FIG. 1 is a block diagram of a mobile terminal according to an exemplary embodiment of the present invention;

FIG. 2 is a flow chart of a sleep initiation process according to an exemplary embodiment of the present invention;

FIG. 3 is a flow chart of a sleep recovery process according to an exemplary embodiment of the present invention;

FIG. 4 is a block diagram of a timer management system according to an exemplary embodiment of the present invention;

FIG. 5 is a timing diagram illustrating a timer event window according to an exemplary embodiment of the present invention;

FIG. 6 is an activity diagram illustrating usage of timer information according to an exemplary embodiment of the present invention;

FIG. 7A is a timing diagram illustrating an example of event management without utilization of timer event thresholds in conjunction with other system events;

FIG. 7B is a timing diagram illustrating an example of event management with utilization of timer event thresholds in conjunction with other system events;

FIG. 8A is a timing diagram illustrating another example of event management without utilization of timer event thresholds in conjunction with other timer events;

FIG. 8B is a timing diagram illustrating another example of event management with utilization of timer event thresholds in conjunction with other timer events;

FIG. 9A is a timing diagram illustrating yet another example of event management without utilization of timer event thresholds in conjunction with other system events;

FIG. 9B is a timing diagram illustrating yet another example of event management with utilization of timer event thresholds in conjunction with other system events;

FIG. 10 is a flow chart illustrating an exemplary embodiment of utilizing timer event threshold information; and

FIG. 11 is a flow chart illustrating another exemplary embodiment of utilizing timer event threshold information.

### DETAILED DESCRIPTION OF THE DRAWINGS

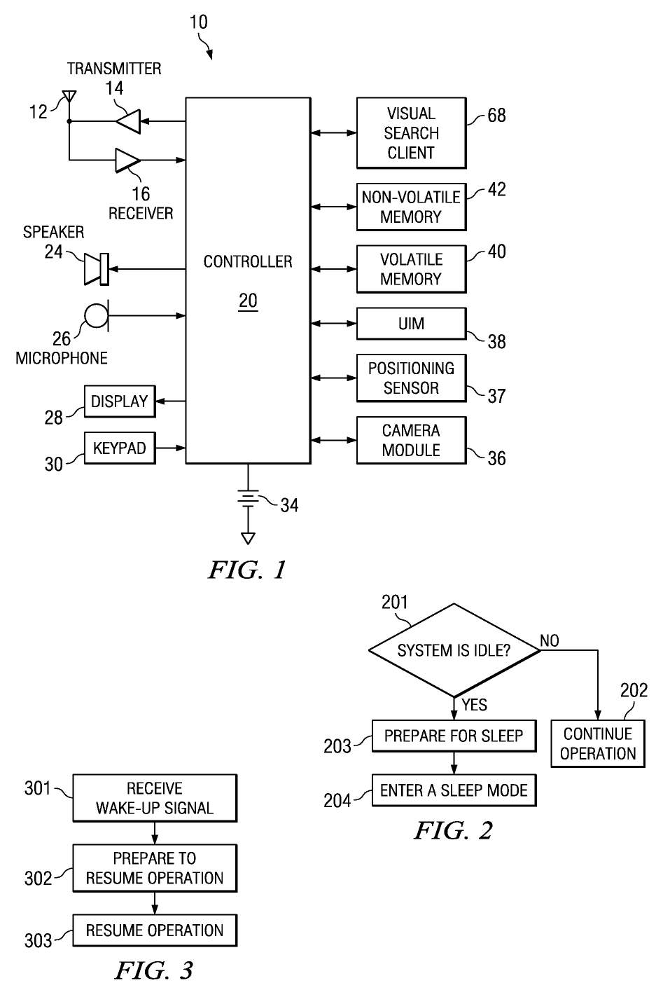

The preferred embodiment of the present invention and its advantages are best understood by referring to FIGS. 1 through 11 of the drawings, like numerals being used for like and corresponding parts of the various drawings.

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements.

Although sleep capabilities in devices having microprocessors have provided a powerful mechanism to reduce power consumption, there is a cost associated with such sleep capabilities. There is often a certain amount of time and power required to enter a sleep mode and to exit a sleep mode. For example, a device performing a set of operations in a single contiguous block of time will save a greater amount of power using sleep capabilities than will a device performing the same operations in multiple blocks of time. Therefore, it would be beneficial to reduce the number of transitions to and from sleep mode.

One of the sources of sleep interruption is a system timer event. Due to the nature of timer services used by a device or applications running on a device, there are system timer events scheduled at various intervals depending upon the components utilizing the system timer events. Therefore, it would be beneficial to reduce the number of system timer events that interrupt sleep mode so that the power consumed during sleep and wake transitions may be reduced.

FIG. 1 is a block diagram of a mobile terminal according to an exemplary embodiment of the present invention. It should be understood, however, that a mobile terminal as illustrated and hereinafter described is merely illustrative of one type of electronic device that would benefit from embodiments of the present invention and, therefore, should not be taken to limit the scope of embodiments of the present invention. While one embodiment of the mobile terminal 10 is illustrated and will be hereinafter described for purposes of example, other types of electronic devices, such as, but not limited to, portable digital assistants (PDAs), pagers, mobile computers, desktop computers, televisions, gaming devices, laptop computers, cameras, video recorders, GPS devices and other types of electronic systems, may readily employ embodiments of the present invention. Furthermore, devices may readily employ embodiments of the present invention regardless of their power source or intent to provide mobility.

Embodiments of the present invention will be primarily described below in conjunction with mobile communications applications. However, it should be understood that embodiments of the present invention may be utilized in conjunction with a variety of other applications, both in the mobile communications industries and outside of the mobile communications industries.

The mobile terminal 10 comprises an antenna 12 (or multiple antennae) in operable communication with a transmitter 14 and a receiver 16. The mobile terminal 10 further comprises a controller 20 or other processing element that provides signals to and receives signals from the transmitter 14 and receiver 16, respectively. The signals comprise signaling information in accordance with the air interface standard of the applicable cellular system, and also user speech, received data and/or user generated data. In this regard, the mobile terminal 10 may operate with one or more air interface standards, communication protocols, modulation types, and access types. By way of illustration, the mobile terminal 10 may operate in accordance with any of a number of first, second, third and/or fourth-generation communication protocols or the like. For example, the mobile terminal 10 may operate in accordance with second-generation (2G) wireless communication protocols IS-136 (TDMA), GSM, and IS-95 (CDMA), or with third-generation (3G) wireless communication protocols, such as UMTS, CDMA2000, WCDMA and TD-SCDMA, with fourth-generation (4G) wireless communication protocols, and/or the like.

It is understood that the controller 20 comprises circuitry desirable for implementing audio and logic functions of the mobile terminal 10. For example, the controller 20 may comprise a digital signal processor device, a microprocessor device, various analog to digital converters, digital to analog converters, and for other support circuits. Control and signal processing functions of the mobile terminal 10 are allocated between these devices according to their respective capabilities. The controller 20 thus may also comprise the functionality to convolutionally encode and interleave message and data prior to modulation and transmission. The controller 20 may additionally comprise an internal voice coder, and may comprise an internal data modem. Further, the controller 20 may comprise functionality to operate one or more software programs, which may be stored in memory. For example, the controller 20 may operate a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a ringer, a conventional earphone and/or speaker 24, a microphone 26, a display 28, and a user input interface, which are coupled to the controller 20. The user input interface, which allows the mobile terminal 10 to receive data, may comprise any of a number of devices allowing the mobile terminal 10 to receive data, such as a keypad 30, a touch display (not shown) or other input device. In embodiments including the keypad 30, the keypad 30 may comprise the conventional numeric (0-9) and related keys (#, *), and other keys used for operating the mobile terminal 10. Alternatively, the keypad 30 may comprise a conventional QWERTY keypad arrangement. The keypad 30 may also comprise various soft keys with associated functions. In addition, or alternatively, the mobile terminal 10 may comprise an interface device such as a joystick or other user input interface. The mobile terminal 10 further comprises a battery 34, such as a vibrating battery pack, for powering various circuits that are required to operate the mobile terminal 10, as well as optionally providing mechanical vibration as a detectable output.

In an exemplary embodiment, the mobile terminal 10 comprises a media capturing element, such as a camera, video and/or audio module, in communication with the controller 20. The media capturing element may be any means for capturing an image, video and/or audio for storage, display or transmission. For example, in an exemplary embodiment in which the media capturing element is a camera module 36, the camera module 36 may comprise a digital camera which may form a digital image file from a captured image. As such, the camera module 36 comprises hardware, such as a lens or other optical component(s), and/or software necessary for creating a digital image file from a captured image. Alternatively, the camera module 36 may comprise only the hardware for viewing an image, while a memory device of the mobile terminal 10 stores instructions for execution by the controller 20 in the form of software for creating a digital image file from a captured image. In an exemplary embodiment, the camera module 36 may further comprise a processing element such as a co-processor which assists the controller 20 in processing image data and an encoder and/or decoder for compressing and/or decompressing image data. The encoder and/or decoder may encode and/or decode according to a standard format, for example, a JPEG standard format.

The mobile terminal 10 may further comprise a user identity module (UIM) 38. The UIM 38 may be a memory device having a built in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a mobile subscriber. In addition to the UIM 38, the mobile terminal 10 may be equipped with memory. For example, the mobile terminal 10 may comprise volatile memory 40, such as volatile Random Access Memory (RAM) including a cache area for the temporary storage of data. The mobile terminal 10 may also comprise other memory, for example, non-volatile memory 42, which may be embedded and/or may be removable. The non-volatile memory 42 may additionally or alternatively comprise an EEPROM, flash memory or the like, such as that available from the SanDisk Corporation of Sunnyvale, Calif., or Lexar Media Inc. of Fremont, Calif. The memories may store any of a number of pieces of information, and data, used by the mobile terminal 10 to implement the functions of the mobile terminal 10. For example, the memories may comprise an identifier, such as an international mobile equipment identification (IMEI) code, which may uniquely identify the mobile terminal 10.

Although FIG. 1 illustrates an example of a mobile terminal which may utilize embodiments of the present invention, it should be understood that the mobile terminal 10 of FIG. 1 is merely an exemplary device that may utilize embodiments of the present invention. Generally speaking, any device having a processing element for managing timer operations may utilize embodiments of the present invention. In this regard, for example, such a device may also comprise or otherwise be in communication with a memory device and may also comprise some form of user interface. For example, such devices could be, but are not limited to, portable digital assistants (PDAs), pagers, mobile computers, desktop computers, televisions, gaming devices, laptop computers, cameras, video recorders, GPS devices and other types of electronic systems. A processing element such as those described above may be embodied in many ways. For example, the processing element may be embodied as a processor, a coprocessor, a controller or various other processing means or devices including integrated circuits such as, for example, an ASIC (application specific integrated circuit), FPGA (field programmable gate array), and/or the like.

FIG. 2 is a flow chart of a sleep initiation process 200 according to an exemplary embodiment of the present invention. It should be understood, however, that the sleep initiation process of FIG. 2 as illustrated and hereinafter described is merely illustrative of one type of sleep initiation process which may be employed to achieve power savings by, slowing or ceasing certain operations, and therefore, should not be taken to limit the scope of the present invention.

At block 201, a system determines whether or not the system is idle. For example, work load of a processing element associated with the system may be verified to determine if the system is idle. Idle verification 201 may take place at various times during operation and within various parts of a system. In an exemplary embodiment, at block 201, an operating system of an electronic device, for example, mobile terminal 10 of FIG. 1, which executes operations in multiple processes, verifies that there are no further processes scheduled to run after a process completes a set of operations. However, it should be understood that other types of verification are possible. If the system is not idle, at block 202 the processor continues its normal operation.

If the system is idle, at block 203 the system will prepare for sleep. In an exemplary embodiment, at block 203, the system may perform the following operations: storing processor register values, preparing peripheral devices for waking capabilities, shutting down peripheral devices, and/or the like. It should be understood that this block is shown merely as an example of operations that may take place before a sleep mode is entered. These operations may take place at various times during system operation and within various parts of the system.

At block 204, the system enters a sleep mode. In an exemplary embodiment, at block 204 a system may shut down certain peripheral devices as part of entering into the sleep mode. In another exemplary embodiment, at block 204 the system may enter a partial sleep mode which preserves register data, but stops processor operation, which may not require any string of processor register values.

In yet another exemplary embodiment, at block 204 when the system enters a sleep mode, the system may perform one or more of the following operations: stopping the processor, stopping the system clock, and/or the like. It should be understood that depending upon the system design and the sleep options embodied in the system, different operations may be performed.

FIG. 3 is a flow chart of a sleep recovery process 300 according to an exemplary embodiment of the present invention. It should be understood, however, that the sleep recovery process of FIG. 3 as illustrated and hereinafter described is merely illustrative of one type of sleep recovery process which may be employed, and therefore, should not be taken to limit the scope of the present invention.

In an exemplary embodiment, at block 301 a wakeup signal is received. The wakeup signal may be generated by a single or a plurality of devices including, but not limited to, an interrupt controller, a timer, a keyboard, a mouse, a communication peripheral device, and/or the like. If desired, filtering may be performed so that only specific signals may initiate the sleep recovery process. At block 302 the system will prepare to resume operation. This preparation may comprise a single or a plurality of operations comprising: restoring processor register values, resuming peripheral device operation, clearing relevant status indications, and/or the like. It should be understood that these are merely examples of operations that may take place before normal operation is resumed. It should be understood that these operations may also be a part of the resume operation at block 303 and may not exist as a distinct step. At block 303 the system will resume operation, which may involve the following operations: starting a system clock, starting processor operation, and/or the like.

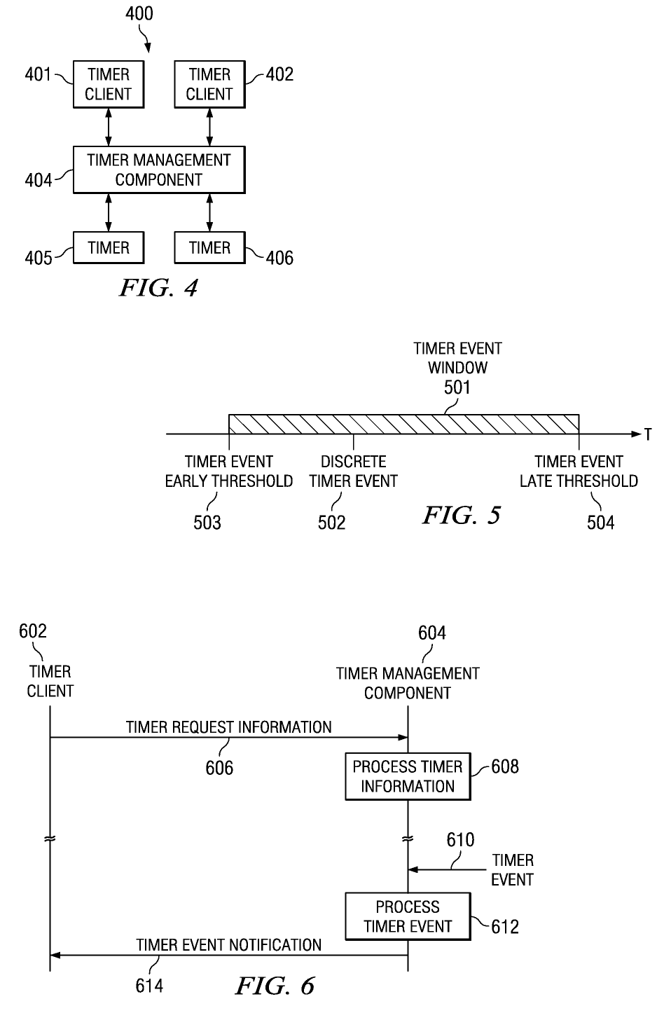

FIG. 4 is a block diagram of a timer management system 400 according to an exemplary embodiment of the present invention. It should be understood, however, that timer management system 400 of FIG. 4 as illustrated and hereinafter described is merely illustrative of an exemplary embodiment which may be employed to realize the benefits of the present invention and, therefore, should not be taken to limit the scope of the present invention.

Timer management system 400 comprises a timer management component 404. Timer management component 404 receives information relating to timer services from a single or a plurality of timer clients 401, 402. Timer management component 404 manages a single or plurality of timers 405, 406. Timer management component 404 may utilize information communicated by timer clients 401, 402 and provide notification to timer clients 401, 402 relating to elapse of a specified amount of time. In an exemplary embodiment, a timer event represents a notification that a certain amount of time has elapsed. In an exemplary embodiment, a system timer event represents a timer event for terminating a sleep cycle. However, in some situations it may be appropriate to refer to a system timer event as a timer event. Timer management component 404 is merely exemplary of any component, part of component, or set of components that performs the operations described hereinafter, and should not be taken to limit the scope of the present invention. For example, timer services described hereinafter may be an integral or separable part of an operating system or a virtual machine, a function of a hardware peripheral, an integrated part of a microprocessor system, and/or the like.

In an exemplary embodiment, timers 405, 406 refer to a single timer or a plurality of timers which inform timer management component 404 either directly or indirectly when a defined amount of time has elapsed. In an exemplary embodiment, these timers accept a value which represents an amount of time to inform a client, for example, timer management component 404, when the time has elapsed, and/or the like. However, the timer may perform other functions. For example, there may be additional methods for controlling these timers such as, for example, enhancing start and stop synchronization, and pause functionality. Each timer may either be capable of preempting a sleep cycle, or may be incapable of preempting a sleep cycle upon its expiration. Although in FIG. 4, these timers are shown as abstract components, the timers may be implemented, wholly or partially in: software, hardware, firmware, and/or the like.

In an exemplary embodiment, timer clients 401, 402 represent components that are requesting a timer service provided by the timer management component 404. There may be a single or a plurality of timer client components at any given. However, it should be understood that the system may be implemented so that there may be a fixed number of timer clients or a dynamic number of timer clients. The timer clients represent any functionality that relies upon the services of the timer management component 404. This functionality may be embodied in: software programs, applications, processes, operating system, firmware, hardware, and/or the like. In an exemplary embodiment, timer clients 401, 402 communicate a value representing the amount of time desired to elapse before receiving a notification of the elapsed time from the timer management component 404.

During normal operation of a system that uses a timer service, there are many different components within the system that may utilize the timer service. However, not all of the timer clients may have firm precision constraints on the timer event. For example, a timer client may tolerate receiving a timer event early by a certain amount of time or late by a certain amount of time. For example, an alarm clock program may request a timer event at a certain time interval, but may be able to tolerate receiving the timer event up to 1 second early or up to 1 second late. In another example, a communication program may request a certain time interval for a timeout type of timer event, but may be able to tolerate receiving the timer event up to 30 milliseconds late, but may not tolerate receiving the timer event early. Although the aforementioned examples provide illustrations of situations where early and late timer events may be tolerated by a timer client within certain constraints, it should be understood that this principal may be applicable to many additional scenarios that are not enumerated within this document.

FIG. 5 is a timing diagram illustrating a timer event window according to an exemplary embodiment of the present invention. Although the terminology utilized in this diagram refers to the perspective of a timer client, it should be understood that these principals would also apply when different perspectives are utilized. In an exemplary embodiment, a timer event window 501 may be defined by more than one value. In an exemplary embodiment, a discrete timer event 502 represents the time at which a timer client, for example timer client 401 of FIG. 4, has requested to be notified after a specified amount of time has elapsed. In an exemplary embodiment, a timer event early threshold 503 represents the earliest time that the timer client may receive or tolerate receiving the notification of the timer event. In an exemplary embodiment, a timer event late threshold 504 represents the latest time that the timer client may receive or tolerate receiving the notification of the timer event. In an exemplary embodiment, the timer event window 501 represents the time period between the timer event early threshold 503 and the timer event late threshold 504. It should be understood that timer event early threshold 503, discrete timer event 501, timer event late threshold 504, and timer event window 501 may be represented as an absolute time, for example, a real-time clock value reference, or a relative time, for example, a hardware timer tick value or an offset from another discrete timer event, or any combination of absolute or relative representations. It should be further understood that the timer event early threshold 503 may coincide with the discrete timer event 502. Also, the timer event late threshold 504 may coincide with the discrete timer event 502. For example, in a situation where a timer client may tolerate receiving a timer event only at the discrete timer event, and may not tolerate receiving the event notification early or late, both the timer event early threshold and the timer event late threshold would coincide with the discrete timer event. In such a case, timer event window 501 would have a width of zero. In another example, in a situation where a timer client may not tolerate receiving a timer event notification earlier than the requested time, but may tolerate receiving the timer event late by a certain amount of time, the timer event early threshold would coincide with the discrete timer event, while the timer event late threshold would be a certain amount of time later than the discrete timer event. In a further example, in a situation where a timer client may not tolerate receiving a timer event later than the requested time, but may tolerate receiving the timer event early by a certain amount of time, the timer event late threshold would coincide with the discrete timer event, while the timer event early threshold would be a certain amount of time earlier than the discrete timer event. In an exemplary embodiment, the time difference between the discrete timer event and the timer event early threshold may be equal to the time difference between the discrete timer event and the timer event late threshold. In another exemplary embodiment, the time difference between the discrete timer event and the timer event early threshold may be different than the time difference between the discrete timer event and the timer event late threshold.

Although the utilization of both early timer event threshold and late timer event threshold is described, it should be understood that an exemplary embodiment may only utilize one of these types of thresholds. For example, an exemplary embodiment may utilize timer event early thresholds without providing any implementation for a timer event late threshold. Another exemplary embodiment may utilize timer event late thresholds without providing any implementation for a timer event early threshold. Yet another exemplary embodiment may utilize only timer event early thresholds under some conditions, utilize only timer event late thresholds under other conditions, and/or utilize both timer event early thresholds and timer event late thresholds under yet other conditions.

FIG. 6 is an activity diagram illustrating usage of timer information according to an exemplary embodiment of the present invention. It should be understood, however, that the operations in FIG. 6 as illustrated and hereinafter described are merely illustrative of an exemplary embodiment which may be employed to realize the benefits of the present invention and, therefore, should not be taken to limit the scope of the present invention. Some of the operations in FIG. 6 may be omitted and/or supplemented, and may be performed by different components.

In FIG. 6, a timer client 602 communicates with a timer management component 604. In this example, in item 606, timer request information is communicated, for example by timer client 602. This information may comprise: discrete timer event information, timer event early threshold information, timer event late threshold information, information relating to an inference about timer information, timer type information, and/or the like. At block 608, the timer information is processed, for example by timer management component 604. This processing may comprise: creating data structures, populating data structures, interpreting timer request information to generate timer event thresholds, setting a system timer event, and/or the like. At block 610, a timer event is received, for example by timer management component 604. This timer event may be generated by: a timer, an operating system, the timer management component, a peripheral device, and/or the like. If desired, the timer event 610 may be a system timer event. At block 612 the timer event is processed. This processing may comprise: updating timer information, modifying timer related data structures, processing timer event offset information, and/or the like. The timer client then receives a timer event notification 614. This notification may comprise: timer event offset information, timer information, and/or the like.

There are many paradigms which may be used to define timer information, for example, a timer event early threshold, a discrete timer event, a timer event late threshold, and/or the like. It should be understood that timer information determination paradigms described are merely exemplary, and therefore, should not be taken to limit the scope of the present invention. Examples of such paradigms comprise: the timer client directly communicating timer threshold values to the timer management component, the timer management component using standard or default threshold settings for a timer client, for example depending on the type of timer client, the timer management component using acquired knowledge about the timer client which is not directly communicated by the timer client to the timer management component, and or the like. Furthermore, multiple paradigms may be utilized.

In an exemplary embodiment, timer management component receives discrete timer event information, timer event late threshold information, and timer event early threshold information from a timer client, for example in timer request information 606. In this exemplary embodiment, the timer management component may utilize the timer information provided by the timer client. However, the timer management component may utilize an alternative method to determine any missing information or to replace information. For example, a timer client communicates a discrete timer event, a timer event early threshold, and a timer event late threshold and a timer event management component utilizes the thresholds. In another example, a timer client communicates a discrete timer event, a timer event early threshold, and a timer event late threshold and a timer event management component utilizes the discrete timer event and the timer event early threshold, but uses an alternative value to define the timer event late threshold. In yet another example, a timer client communicates a discrete timer event, a timer event early threshold, and a timer event late threshold and a timer event management component utilizes the timer event late threshold, but uses an alternative value to define the timer event early threshold.

In another exemplary embodiment, a timer management component receives less than all timer information from a timer client, for example in timer request information 606. The timer management component utilizes a predefined set of thresholds relating to at least a portion of timer clients. For example, a timer client does not provide any timer event threshold information to a timer management component, but the timer management component utilizes a default early timer event threshold of 10 ms and a default late timer event threshold of 15 ms to define the timer event window.

In yet another exemplary embodiment, a timer management component receives less than all timer information from a timer client, for example in timer request information 606. The timer management component obtains information relating to the timer client to form an inference about the timer event thresholds that are likely to be applicable to the timer client. This information may comprise: the priority of the process in which the timer client is running, a listing of other resources utilized by the timer client, a classification relating to the timer client, and/or the like. For example, if a timer client does not provide timer event threshold information to a timer management component, the timer management component may determine, on it's own, or by communicating with another portion of the system, that the timer client is of a “user alert” classification. In this example, the “user alert” classification may have an associated early timer event threshold of 500 ms and an associated late timer event threshold of 500 ms, which are applied by the timer management component.

In another exemplary embodiment, a timer management component receives information relating to a timer type classification from a timer client, for example in timer request information 606. The timer management component utilizes information associated with this classification to determine the values of the timer event early threshold and the timer event late threshold. For example, a timer client communicates a need for a “timeout timer”. In this example, the “timeout timer” may be a timer with a timer event early threshold coinciding with a discrete timer event and a timer event late threshold of 50 ms later than the discrete timer event. In this example, even though the client does not explicitly communicate the timer event thresholds, the thresholds are implied by the usage of a known classification.

In yet another exemplary embodiment, a timer management component receives a timer event late threshold and a timer event early threshold, but does not receive a discrete timer event from a timer client, for example in timer request information 606. The timer management component may utilize the timer threshold information without determining any discrete timer event information. In this situation, only the timer event early threshold and/or the timer event late threshold may be used to generate timer events. The timer management component may determine the discrete timer event to be a time between the timer event early threshold and the timer event late threshold.

Although each of the aforementioned examples has been described independently, it should be understood that one or more of the above examples may be combined to provide timer information. Furthermore, it should be understood that the timer management component may modify timer information and/or disregard timer information.

There are varying embodiments relating to the communication from a timer client to a timer management component. In an exemplary embodiment, a timer client may send timer information represented by an absolute time, for example a reference to a real-time clock, by relational information, for example, an offset to a discrete timer event, and/or the like. In another exemplary embodiment, a timer client may send information comprising: a timer event early threshold, a discrete timer event, a timer event late threshold, and/or the like. It should be understood that a timer client may send any combination of such information, for example, a timer event early threshold only, a timer event early threshold and a discrete timer event, and/or the like.

In another exemplary embodiment, a timer client sends information relating to a timer type classification from a timer client, for example in timer request information 606. For example, a timer client communicates a need for a “timeout timer”. In this exemplary embodiment, the classification of “timeout timer” may provide at least a partial basis for determining timer information. In this example, the “timeout timer” may be a timer with a timer event early threshold coinciding with a discrete timer event and a timer event late threshold of 50 ms later than the discrete timer event. It should be understood that the timer client may have no knowledge of the timer event thresholds associated with this classification.

In yet another exemplary embodiment, a timer client sends information relating to time criticality of a timer event, for example in timer request information 606. For example, a timer client sends information that the criticality of the timer event is of a “user alert” classification. In this example, the “user alert” classification may have an associated early timer event threshold of 500 ms and an associated late timer event threshold of 500 ms, which are applied by the timer management component. It should be understood that the timer client may have no knowledge of the timer event thresholds associated with this classification.

There are varying embodiments relating to the communication from a timer management component to a timer client. The timer client may be provided with information of a time variation from a discrete timer event and its corresponding timer event. The information of time variation may comprise: an offset to a discrete timer event, an indication that a timer event occurred late, an indication that a timer event occurred early, an absolute time corresponding to a time denoting generation of a timer event, and/or the like. Conversely, the timer client may not be informed of any variation between a discrete timer event and its corresponding timer event.

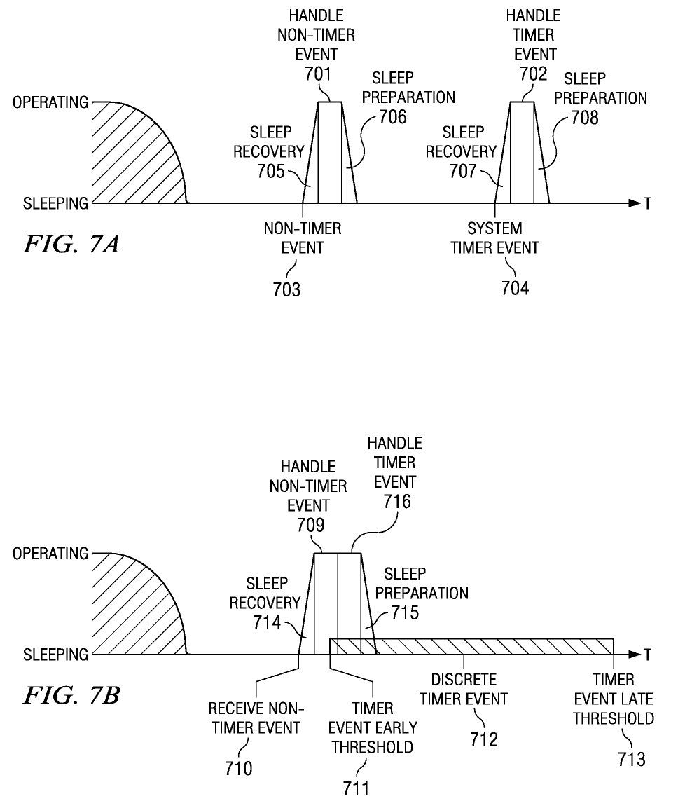

FIG. 7A is a timing diagram illustrating an example of event management without utilization of timer event thresholds in conjunction with other system events. It should be understood that this timing diagram is merely an example of one possible use of timer events, and therefore, should not serve to limit the scope of the present invention.

In FIG. 7A, the system receives a non-timer event 703. The system performs sleep recovery 705, performs the operations to handle the non-timer event 701, and performs sleep preparation 706. At a later point in time, the system receives a system timer event 704. The system performs sleep recovery 707, performs the operations to handle the timer event 702, and performs sleep preparation 708.

FIG. 7B is a timing diagram illustrating an example of event management with utilization of timer event thresholds in conjunction with other system events. It should be understood that this timing diagram is merely an example of one possible use of timer event thresholds, and therefore, should not serve to limit the scope of the present invention.

In FIG. 7B, the system receives a non-timer event 710. The system performs sleep recovery 714 and performs operations to handle the non-timer event 709. There is a discrete timer event 712 with an associated timer event early threshold 711 and timer event late threshold 713. After performing the operations to handle the non-timer event 709, the timer event early threshold 711 has already passed. Since the timer event early threshold 711 has already passed, the system may initiate operations to handle the timer event 716 even though the discrete timer event has not yet passed. The system performs the operations to handle the timer event 716 before sleep preparation 715. The system does not wait for the discrete timer event 712 to handle the timer event 716. Thus, the operations to handle the non-timer event 709 and handle the timer event 716 may be performed, at least approximately, contiguously. It should be understood that even though the terminology contiguously is used, there may be other operations that take place between handling non-timer event 709 and handling timer event 716. Furthermore, the present invention is not limited to handling non-timer and/or timer events contiguously. If desired, two or more timer and/or non-timer events may be handled contiguously without departing from the scope of the present invention.

In comparing FIG. 7A and FIG. 7B, the advantages of handling a timer event early can be seen. It can be seen that while there are two distinct sleep recovery phases 705, 707 in FIG. 7A, there is one distinct sleep recovery phase 714 in FIG. 7B. Likewise, it can be seen that while there are two distinct sleep preparation phases 706, 708 in FIG. 7A, there is one distinct sleep preparation phase 715 in FIG. 7B. In this example, the usage of a timer event early threshold has eliminated a waking phase by performing the operations to handle the timer event 716 during the same wake phase as the operations to handle the non-timer event 709. This reduction of sleep recovery and sleep preparation time may improve time performance of the system and/or power consumption by the system. Furthermore, the approximately contiguous nature of the operations to handle the non-timer event 709 and the operations to handle the timer event 716 may improve time performance of the system and/or power consumption by the system. Thus by combining the handling of non-timer events and/or timer events in the same wake cycle, system performance may be improved.

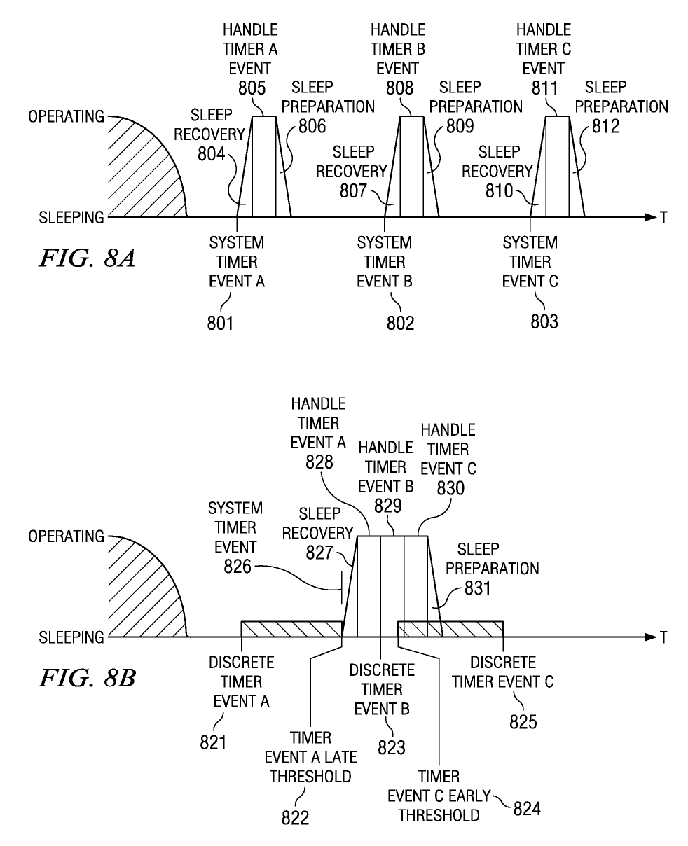

FIG. 8A is a timing diagram illustrating another example of event management without utilization of timer event thresholds in conjunction with other timer events. It should be understood that this timing diagram is merely an example of one possible use of timer events, and therefore, should not serve to limit the scope of the present invention.

In FIG. 8A, the system receives a system timer event A 801. The system performs sleep recovery 804, performs the operations to handle timer event A 805, and performs sleep preparation 806. At a later point in time, the system receives a system timer event B 802. The system performs sleep recovery 807, performs the operations to handle timer event B 808, and performs sleep preparation 809. At a later point in time, the system receives a system timer event C 803. The system performs sleep recovery 810, performs the operations to handle timer event C 811, and performs sleep preparation 812.

FIG. 8B is a timing diagram illustrating another example of event management with utilization of timer event thresholds in conjunction with other timer events. It should be understood that this timing diagram is merely an example of one possible use of timer events, and therefore, should not serve to limit the scope of the present invention.

In FIG. 8B, there is a discrete timer event A 821 with an associated timer event A late threshold 822, a discrete timer event B 823, and a discrete timer event C 824 with an associated timer event C early threshold 825. A timer event 826, which coincides with the timer event A late threshold, terminates a sleep mode and the system begins sleep recovery 827. By setting the system timer event 826 to coincide with the timer event A late threshold 822 instead of the discrete timer event A 821, the system extends the sleep time before performing the operations to handle timer event A 828. The discrete timer event B 823 occurs at the end of operations to handle timer event A 828. The system performs the operations to handle timer event B 829. Therefore, it can be seen that the extended sleep time provided by the utilization of the timer event A late threshold eliminated a sleep/wake cycle between the operations to handle timer event A and the operations to handle timer event B. When the system completes operations to handle timer event B 829, the timer event C early threshold 824 has already elapsed. Since the timer event C early threshold 824 has already passed, the system may initiate operations to handle timer event C 831 even though the discrete timer event has not yet been reached or passed. The system proceeds with operations to handle timer event C 831 before sleep preparation 831. The system does not wait for the discrete timer event C 825 to handle timer event C 830. Thus, the operations to handle timer event A 828, handle timer event B 829, and handle timer event C830, may be performed, at least approximately, contiguously. It should be understood that even though the terminology contiguously is used, there may be other operations that take place between handling timer event A 828, handling timer event B 829, and handling timer event C 830. Furthermore, the present invention is not limited to handling non-timer and/or timer events contiguously. If desired, two or more timer and/or non-timer events may be handled contiguously without departing from the scope of the present invention.

In FIG. 8A and FIG. 8B, it should be understood that the absence of a timer event A early threshold, a timer event B early threshold, a timer event B late threshold, and a timer event C late threshold demonstrate different ways in which the timer event thresholds may be utilized, and therefore should not limit the scope of the present invention. In this example, there may be no values representing a timer event A early threshold, a timer event B early threshold, a timer event B late threshold, and a timer event C late threshold. Likewise, this example may also cover a situation where a timer event A early threshold coincides with the discrete timer event A 821, a timer event B late threshold and timer event B early threshold coincide with the discrete timer event B 823, and a timer event C late threshold.

In comparing FIG. 8A and FIG. 8B, the effects of handling timer events late and early can be seen. It can be seen that while there are three distinct sleep recovery phases 804, 807, 810 in the section denoting behavior without threshold utilization 820, there is one distinct sleep recovery phase 827 in the section denoting behavior with threshold utilization 850. Likewise, it can be seen that while there are three distinct sleep preparation phases 806, 809, 812 in the section denoting behavior without threshold utilization 850, there is one distinct sleep preparation phase 831 in the section denoting behavior with threshold utilization 850. In this example, the usage of a timer event late threshold and a timer event early threshold has eliminated two waking phases by performing the operations to handle the timer event A 828, operations to handle timer event B 829, and operations to handle timer event C during the same wake phase 830. This reduction of sleep recovery and sleep preparation time may improve time performance of the system and/or power consumption by the system. Furthermore, the approximately contiguous nature of the operations to handle the timer event A 828, operations to handle timer event B 829, and operations to handle timer event C may improve time performance of the system and/or power consumption by the system.

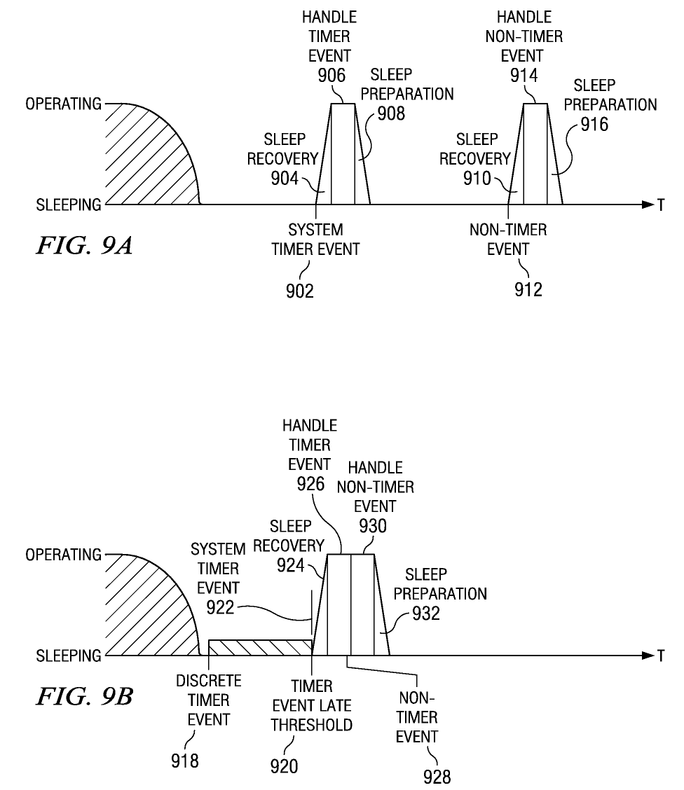

FIG. 9A is a timing diagram illustrating yet another example of event management without utilization of timer event thresholds in conjunction with other system events. It should be understood that this timing diagram is merely an example of one possible use of timer events, and therefore, should not serve to limit the scope of the present invention.

In FIG. 9A, a system timer event 902 occurs. The system performs sleep recovery 904, performs the operations to handle the timer event 906, and performs sleep preparation 908. At a later point in time, the system receives a non-timer event 912. The system performs sleep recovery 910, performs the operations to handle the non-timer event 914, and performs sleep preparation 916.

FIG. 9B is a timing diagram illustrating yet another example of event management with utilization of timer event thresholds in conjunction with other system events. It should be understood that this timing diagram is merely an example of one possible use of timer event thresholds, and therefore, should not serve to limit the scope of the present invention.

In FIG. 9B, a system timer event 922 occurs. It can be seen that the system timer event 922 corresponds with a timer event late threshold 920, and occurs after a discrete timer event 918. The system then performs sleep recovery 924 and performs operations to handle the timer event 926. While performing the operations to handle the timer event 926, a non-timer event 928 occurs. The system performs the operations to handle the non-timer event 930 before sleep preparation 932. Thus, the operations to handle the timer event 926 and handle the non-timer event 930, may be performed, at least approximately, contiguously. It should be understood that even though the terminology contiguously is used, there may be other operations that take place between handling timer event 926 and handling non-timer event 928. Furthermore, the present invention is not limited to handling non-timer and/or timer events contiguously. If desired, two or more timer and/or non-timer events may be handled contiguously without departing from the scope of the present invention.

In comparing FIG. 9A and FIG. 9B, the advantages of handling a timer event late can be seen. It can be seen that while there are two distinct sleep recovery phases 904, and 910 in FIG. 9A, there is one distinct sleep recovery phase 924 in FIG. 9B. Likewise, it can be seen that while there are two distinct sleep preparation phases 908 and 916 in FIG. 9A, there is one distinct sleep preparation phase 932 in FIG. 9B. In this example, the usage of a timer event late threshold has eliminated a waking phase by performing the operations to handle the timer event 926 during the same wake phase as the operations to handle the non-timer event 930. This reduction of sleep recovery and sleep preparation time may improve time performance of the system and/or power consumption by the system. Furthermore, the approximately contiguous nature of the operations to handle the non-timer event 930 and the operations to handle the timer event 926 may improve time performance of the system and/or power consumption by the system. Thus by combining the handling of non-timer events and/or timer events in the same wake cycle, system performance may be improved.

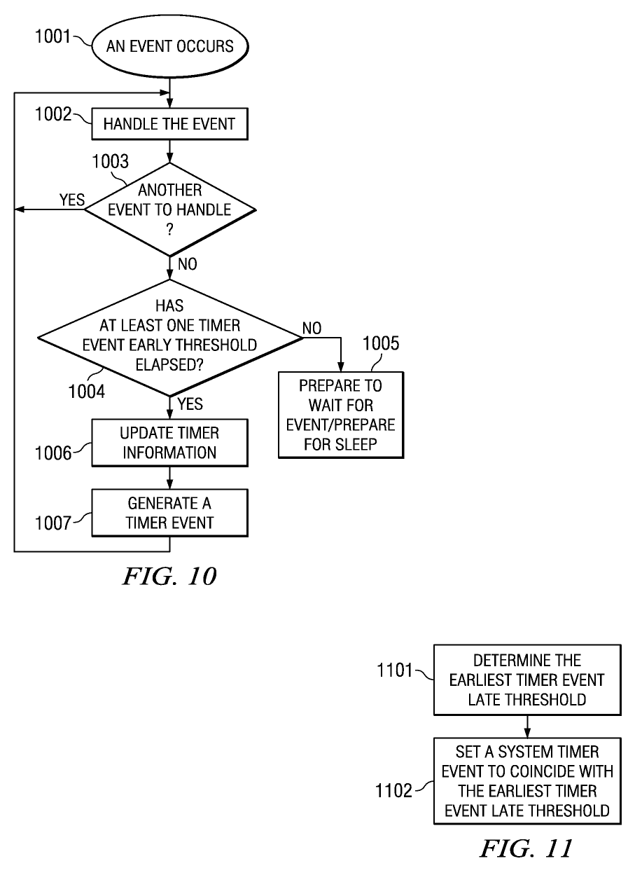

FIG. 10 is a flow chart illustrating an exemplary embodiment of utilizing timer event threshold information. It should be understood that an event may occur at any point during the flow of FIG. 10. The handling of the event may occur preemptively, in series, and/or in parallel with the operations described in FIG. 10. At block 1001, an event occurs. This event may comprise any type of event within a system, for example, a user input event, a system timer event, a timer event, a communication event, and/or the like. The system performs operations to handle the event at block 1002. The operations may comprise performing an event-specific operation, generating an additional event, resetting event status information, and/or the like. At block 1003, the system verifies whether there are more events to handle. If there is another event to handle, the system returns to block 1002 and performs operations to handle the event. It should be understood that the verification of another event to handle may comprise an explicit verification, for example, an actual check of pending events, and/or an implicit verification, for example, the entering of an idle state, process, task, and/or the like. If, at block 1003, there is no other event to handle, then at block 1004, the system verifies whether at least one timer event early threshold has elapsed. It should be understood that the verification of a timer event early threshold elapsing may comprise explicit verification, for example, a check of pending timer event thresholds, and/or an implicit verification, for example, the entering of a state, process, task, and/or the like denoting the elapse of a timer event early threshold. If no timer event early threshold has elapsed, then at block 1005, the system performs operations to prepare to wait for an event and/or prepare for sleep. These operations may comprise: evaluating late timer thresholds, storing processor register values, preparing peripheral devices for waking capabilities, shut down peripheral devices, and/or the like. For example, these operations may be the operations to prepare for sleep at block 203 of FIG. 2. At block 1004, if the system determines that a timer event early threshold has elapsed, then at block 1006 the system may update the timer information. In an exemplary embodiment, this timer information may comprise any data structure and/or class representing at least information necessary for managing timer events. For example, the timer information may comprise one or more queues, lists, linked lists, databases, tree of timer information representations, and/or the like. At block 1007, the system may generate a timer event which will invoke block 1002 to perform operations to handle the event. It should be understood that this flow may be performed any number of times as to handle timer event early thresholds.

FIG. 11 is a flow chart illustrating another exemplary embodiment of utilizing timer event threshold information. It should be understood that an event may occur at any point during the flow of FIG. 11, and that the handling of the event may occur preemptively, in series, and/or in parallel with the operations described in FIG. 11. It should be understood that the operations described in FIG. 11 may be performed at various points in the operation of the system. For example, the FIG. 11 operations may be performed prior to preparing to sleep, performed prior to preparing to wait for next event, performed when populating timer information in a data structure, and/or the like. At block 1101, the system may determine the earliest, if any, timer event late threshold to be handled 1101. This evaluation may include discrete timer event values as appropriate. For example, in a situation where there is no late timer event threshold defined, a system may assume a timer event late threshold to coincide with a discrete timer event. At block 1102, the system may set a system timer event to coincide with the earliest determined timer event late threshold. In an exemplary embodiment, the system may compare a plurality of timer event late thresholds and discrete timer events to determine the latest time a system timer event may occur without violating any late timer thresholds.

Embodiments of the present invention may be implemented in software, hardware, application logic or a combination of software, hardware and/or application logic. The software, application logic and/or hardware may reside on a single or a plurality of devices. If desired, part of the software, application logic and/or hardware may reside on a device, part of the software, application logic and/or hardware may reside on another part of the device, and part of the software, application logic and/or hardware may reside on a different device. The application logic, software or an instruction set is preferably maintained on any one of various conventional computer-readable media. In the context of this document, a “computer-readable medium” may be any media or means that may contain, store, communicate, propagate or transport the instructions for use by or in connection with an instruction execution system, apparatus, or device.

If desired, the different functions discussed herein may be performed in any order and/or concurrently with each other. Furthermore, if desired, one or more of the above-described functions may be optional or may be combined.

It is also noted herein that while the above describes exemplifying embodiments of the invention, there are several variations and modifications which may be made without departing from the scope of the present invention as defined in the appended claims.

What is claimed is:

1. A method, comprising:
receiving a timer event request; and
generating a timer event based at least in part on at least one criterion other than a discrete timer event associated with said timer event request.

2. The method of claim 1, wherein said receiving and said generating are performed by an operating system.

3. The method of claim 1, wherein said at least one criterion comprises a timer event early threshold.

4. The method of claim 1, wherein said at least one criterion comprises a timer event late threshold.

5. The method of claim 1, wherein said at least one criterion comprises information that is received from a timer client.

6. The method of claim 1, wherein said at least one criterion comprises information other than information received from a timer client.

7. The method of claim 1, wherein said at least one criterion comprises at least one predetermined timer event threshold setting.

8. The method of claim 1, wherein said at least one criterion is a classification relating to a timer client.

9. The method of claim 1, further comprising evaluating said at least one criterion prior to preparing to wait for at least one of: said timer event, a second timer event, and a non-timer event.

10. The method of claim 1, wherein generating said timer event is further based at least in part on a discrete timer event.

11. The method of claim 1, wherein generating said timer event is based wholly on at least one criterion other than a discrete timer event.

12. The method of claim 1, wherein said at least one criterion comprises an absolute time.

13. The method of claim 1, wherein said at least one criterion comprises an offset from said discrete timer event.

14. The method of claim 1, wherein said timer event is generated earlier than said discrete timer event would have been generated.

15. The method of claim 1, wherein said timer event is generated later than said discrete timer event would have been generated.

16. The method of claim 1, further comprising determining when to enter a sleep mode.

17. The method of claim 1, further comprising determining when to recover from a sleep mode.

18. The method of claim 16, wherein said determining when to enter a sleep mode comprises verifying whether at least one timer event early threshold has elapsed.

19. The method of claim 17, wherein said determining when to recover from a sleep mode comprises determining time at which at least one of a plurality of timer event late thresholds occurs.

20. A computer program product comprising at least one computer-readable storage medium having computer-readable program code portions stored therein, the computer-readable program code portions comprising:
a first executable portion for receiving a timer event request; and
a second executable portion for generating a timer event based at least in part on at least one criterion other than a discrete timer event associated with said timer event request.

21. The computer program product of claim 20, wherein said at least one criterion comprises a timer event early threshold.

22. The computer program product of claim 20, wherein said at least one criterion comprises a timer event late threshold.

23. An apparatus, comprising:
a processing element configured to:
receive a timer event request; and
generate a timer event based at least in part on at least one criterion other than a discrete timer event associated with said timer event request.

24. The apparatus of claim 23, wherein said at least one criterion comprises information that is received from a timer client.

25. The apparatus of claim 23, wherein said at least one criterion comprises information other than information received from a timer client.

26. A method comprising,
sending a timer event request; and
sending at least one criterion to provide at least partial basis for generation of a timer event associated with said timer event request other than a discrete timer event.

27. The method of claim 26, wherein said at least one criterion comprises a timer event early threshold.

28. The method of claim 26, wherein said at least one criterion comprises a timer event late threshold.

29. The method of claim 26, wherein said at least one criterion comprises a classification relating to timer event information.

30. The method of claim 26, wherein said at least one criterion comprises time criticality information relating to a timer client.

31. The method of claim 26, wherein said at least one criterion comprises a classification relating to a timer client.

32. The method of claim 26, further comprising sending said discrete timer event.

33. The method of claim 26, wherein said at least one criterion comprises an absolute time.

34. The method of claim 26, wherein said at least one criterion comprises an offset from said discrete timer event.

35. The method of claim 26, further comprising receiving a notification of said timer event.

36. The method of claim 35, further comprising receiving information relating to said timer event occurring earlier than said discrete timer event.

37. The method of claim 35, further comprising receiving information relating to said timer event occurring later than said discrete timer event.

38. A computer program product comprising at least one computer-readable storage medium having computer-readable program code portions stored therein, the computer-readable program code portions comprising:
a first executable portion for sending a timer event request; and
a second executable portion for sending at least one criterion to provide at least partial basis for generation of a timer event other than a discrete timer event associated with said timer event request.

39. The computer program product of claim 38, wherein said at least one criterion comprises a timer event early threshold.

40. The computer program product of claim 38, wherein said at least one criterion comprises a timer event late threshold.

41. The computer program product of claim 38, wherein said at least one criterion comprises a classification relating to timer event information.

42. The computer program product of claim 38, wherein said at least one criterion comprises time criticality information relating to a timer client.

43. The computer program product of claim 38, wherein said at least one criterion comprises a classification relating to a timer client.

44. The computer program product of claim 38, further comprising a third executable portion for sending said discrete timer event.

45. The computer program product of claim 38, wherein said at least one criterion comprises an absolute time.

46. The computer program product of claim 38, wherein said at least one criterion comprises an offset from said discrete timer event.

47. The computer program product of claim 38, further comprising a third executable portion for receiving a notification of said timer event.

48. The computer program product of claim 47, further comprising a fourth executable portion for receiving information relating to said timer event occurring earlier than said discrete timer event.

49. The computer program product of claim 47, further comprising a fourth executable portion for receiving information relating to said timer event occurring later than said discrete timer event.

50. An apparatus, comprising:
a processing element configured to:
send a timer event request; and
send at least one criterion to provide at least partial basis for generation of a timer event associated with said timer event request other than a discrete timer event.
